(19) United States
(12) Patent Application Publication
(10) Pub. No.: US 2011/0115440 A1
(43) Pub. Date: May 19, 2011

(54) SECONDARY BATTERY CHARGE METHOD AND BATTERY CHARGER

(75) Inventors: Yuichi Sabi, Tokyo (JP); Yui Senda, Kanagawa (JP); Reina Ito, Kanagawa (JP); Tatsuya Furuya, Kanagawa (JP); Hiroyuki Morioka, Kanagawa (JP)

(73) Assignee: SONY CORPORATION, Tokyo (JP)

(21) Appl. No.: 12/938,549

(22) Filed: Nov. 3, 2010

(30) Foreign Application Priority Data
Nov. 18, 2009 (JP) P2009-263348

(51) Int. Cl. H02J 7/04

(52) U.S. Cl. 320/145

(57) ABSTRACT

Disclosed herein is a secondary battery charge method, including the steps of: conducting a pulsed charge control adapted to conduct a pulsed charge by repeating a cycle of a charge condition and a pause condition of a secondary battery at predetermined intervals; detecting a voltage detection adapted to detect the voltage of the secondary battery; determining a charge termination determination adapted to determine whether to terminate the charge of the secondary battery based on the battery voltage in a pause condition detected by the voltage detection step; and terminating a charge termination control adapted to terminate the pulsed charge when it has been determined by the charge termination determination step that the charge should be terminated.

### CROSS REFERENCES TO RELATED APPLICATIONS

The present application claims priority to Japanese Priority Patent Application JP 2009-263348 filed with the Japan Patent Office on Nov. 18, 2009, the entire content of which is hereby incorporated by reference.

### BACKGROUND

The present application relates to a secondary battery charge method and battery charger. The present application relates more particularly to a charge method and battery charger for charging a secondary battery using a positive active material whose ionic conductivity changes steeply in the discharge process.

In general, nonaqueous electrolyte secondary batteries such as lithium-ion secondary batteries offer higher energy density than other types of secondary batteries such as nickel-cadmium and nickel-hydrogen batteries. As a result, these secondary batteries have found wide application in mobile electronic equipment including laptop personal computers, mobile phones and digital cameras. On the other hand, thin film solid-state batteries can be incorporated in electronic circuit boards in an on-chip manner. Further, these batteries are incorporated in electronic money cards, radio frequency (RF) tags and so on as flexible bendable batteries. Recent years have seen calls for smaller and lighter secondary batteries with higher capacity and shorter charge time in response to growing needs for smaller and lighter mobile electronic equipment and money cards with higher performance.

As of today, LiCoO₂, LiMn₂O₄ and LiFePO₄ have been, for example, commercialized as positive active materials for use in secondary lithium-ion batteries. However, a variety of new materials are now under study to achieve even higher performance and lower cost.

Incidentally, in order to charge a nonaqueous electrolyte secondary battery, a constant current/constant voltage charge is generally used. This method is a combination of a constant current charge and constant voltage charge and charges a battery at a constant current until the battery voltage reaches a given voltage, and then charges the battery at a constant voltage until a full charge is achieved. With this method, the battery is charged quickly in a short period of time at a constant current first, followed by a constant voltage charge, thus preventing the degradation of the battery performance caused by a steep rise in battery voltage. During a constant current/constant voltage charge, the current during charge is used to monitor whether the charge is complete.

On the other hand, a method has been proposed to determine whether a charge is complete (Japanese Patent No. 3271138 hereinafter as Patent Document 1). This method does so firstly by performing a pulsed charge and secondly by detecting the open circuit voltage (OCV) during a pause condition. A pulsed charge is conducted by repeating a cycle of a charge condition and a pause condition at predetermined intervals. In a charge condition, a secondary battery is supplied with a charge current for charging. In a pause condition, a charge current is shut off to pause the charge.

### SUMMARY

However, measuring the open circuit voltage as disclosed in Patent Document 1 is designed to determine whether the charge is complete by finding the envelope of the open circuit voltage. This method is similar to the existing art in that it monitors the reached voltage level appropriate to the charge.

With some positive active materials, the ionic conductivity changes steeply at a given stage of the charge and discharge process. More specifically, the ionic conductivity drops significantly at an early stage of the discharge. The ionic conductivity rises at a given stage of the discharge process as the discharge continues. If a secondary battery using such a positive active material is used, the change in ionic conductivity cannot be detected by monitoring the voltage or current level during the charge. Further, detecting the open circuit voltage during a pause condition alone as disclosed in Patent Document 1 cannot detect the change in ionic conductivity. Therefore, even if a secondary battery using a positive active material having such a property is charged by an existing method, it is impossible to determine with accuracy whether the charge is complete, thus causing the battery to be charged beyond a desired level. Charging the secondary battery beyond a desired level, i.e., overcharging the battery, leads to degraded characteristics of the battery or shorter service life.

In light of the foregoing, there is a need for the present invention to provide a secondary battery charge method and battery charger that can terminate the charge by accurately detecting the change in ionic conductivity when charging a secondary battery using a positive active material whose ionic conductivity changes steeply at a given stage.

In order to solve the above need, a first embodiment is a secondary battery charge method that includes a pulsed charge control step, voltage detection step, charge termination determination step and charge termination control step. The charge control step conducts a pulsed charge by repeating a cycle of a charge condition and a pause condition of a secondary battery at predetermined intervals. The voltage detection step detects the voltage of the secondary battery. The charge termination determination step determines whether to terminate the charge of the secondary battery based on the battery voltage in a pause condition detected by the voltage detection step. The charge termination control step terminates the pulsed charge when it has been determined by the charge termination determination step that the charge should be terminated.

A second embodiment is a secondary battery charger that includes a pulsed charge control unit, voltage detection unit, charge termination determination unit and charge termination control unit. The charge control unit conducts a pulsed charge by repeating a cycle of a charge condition and a pause condition of a secondary battery at predetermined intervals. The voltage detection unit measures the voltage of the secondary battery. The charge termination determination unit determines whether to terminate the charge of the secondary battery based on the battery voltage in a pause condition detected by the voltage detection unit. The charge termination control unit terminates the pulsed charge when it has been determined by the charge termination determination unit that the charge should be terminated.

An embodiment permits charge and discharge only in a high ionic conductivity range when a secondary battery is charged and discharged which uses a positive active material whose ionic conductivity changes steeply at a given stage in the discharge process. This makes it possible for the secondary battery to function properly, thus allowing for quick charge and discharge. Further, an embodiment permits accurate determination as to whether the charge is complete by monitoring the change in voltage as a result of the change in ionic conductivity, thus preventing overcharge of the secondary battery.

Additional features and advantages are described herein, and will be apparent from the following Detailed Description and the figures.

### BRIEF DESCRIPTION OF THE FIGURES

FIGS. 1A to 1C are diagrams illustrating schematic structures of a solid-state lithium-ion battery used in an embodiment;

FIG. 2 is a graph illustrating the charge characteristic of the solid-state lithium-ion battery used in an embodiment when the battery is charged through constant current/constant voltage charge;

FIG. 3 is a graph illustrating the discharge characteristic of the solid-state lithium-ion battery used in an embodiment when the battery is discharged;

FIG. 4 is a graph illustrating the charge characteristic of the solid-state lithium-ion battery used in an embodiment when the battery is charged through existing pulsed charge;

FIG. 5 is a graph illustrating the discharge characteristic of the solid-state lithium-ion battery used in an embodiment when the battery is charged through existing pulsed charge and discharged;

FIG. 6 is a graph illustrating the relationship between the battery voltage and charge time when the solid-state lithium-ion battery used in an embodiment is charged through existing pulsed charge;

FIG. 7 is a block diagram illustrating the configuration of a charger according to a first embodiment;

FIG. 8 is a flowchart illustrating the process steps performed by a control section in the first embodiment;

FIG. 9 is a graph illustrating the rate of change (slope) of an open circuit voltage for a period of five seconds after a pause condition begins during a pulsed charge;

FIG. 10 is a graph illustrating the charge characteristic of the solid-state lithium-ion battery charged through pulsed charge by the charger according to the embodiment;

FIG. 11 is a graph illustrating the discharge characteristic of the solid-state lithium-ion battery charged through pulsed charge by the charger according to the embodiment;

FIG. 12 is a graph illustrating the change in the rate of change (slope) between pause conditions of pulsed charge;

FIG. 13 is a block diagram illustrating the configuration of a charger according to a second embodiment; and

FIG. 14 is a flowchart illustrating the process steps performed by the control section in the second embodiment.

### DETAILED DESCRIPTION

The present application will be described in detail below with reference to the drawings according to an embodiment. It should be noted that the description will be given in the following order:

1. First Embodiment (example in which the rate of change (slope) of the open circuit voltage is compared against a first threshold)

2. Second Embodiment (example in which the change in the rate of change (slope) of the open circuit voltage is compared against a second threshold)

### 1. First Embodiment

Solid-State Lithium-Ion Secondary Battery and Positive Active Material Used in the Present Invention

Configuration of Solid-State Lithium-Ion Battery and Film Formation Conditions

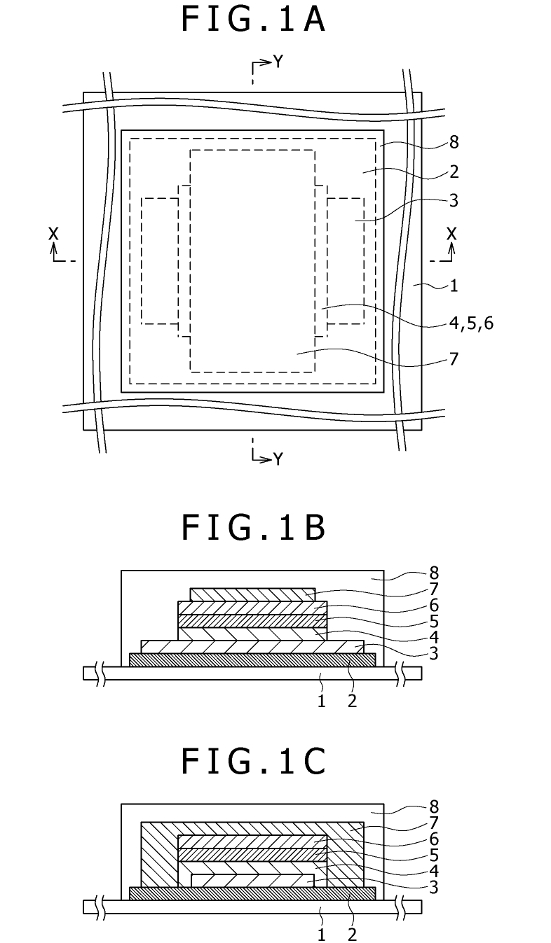

FIGS. 1A to 1C are diagrams illustrating schematic structures of the solid-state lithium-ion battery used in an embodiment. This solid-state lithium-ion battery is a chargeable/dischargeable battery. FIG. 1A is a plan view; FIG. 1B a sectional view taken along line X-X in FIG. 1A; and FIG. 1C a sectional view taken along line Y-Y in FIG. 1A.

As illustrated in FIGS. 1A to 1C, the solid-state lithium-ion battery has a laminated body. The laminated body includes an inorganic insulating film 2 provided on a substrate 1 and a metal mask provided on the inorganic insulating film 2. The laminated body further includes, in a given region on the inorganic insulating film 2, a Ti film serving as a positive current collector film 3, a positive active material film 4, solid-state electrolyte film 5, negative potential formation layer 6 and negative current collector film 7. Still further, an overall protective film 8 made of an ultraviolet hardening resin, for example, is formed to cover the entire laminated body. A Ti film is formed as the positive current collector film 3. A LiCuPO₄ film is formed as the positive active material film 4. A Li₃PO₄Nₓ film is formed as the solid-state electrolyte film 5. A LiCoO₂ film is formed as the negative potential formation layer 6. A Ti film is formed as the negative current collector film 7. It should be noted that a polycarbonate (PC) substrate of 1.1 mm in thickness is used as the substrate 1. On the other hand, SCZ (SiO₂—Cr₂O₃—ZrO₂) is formed as the inorganic insulating film 2 over the entire surface of the substrate 1.

The inorganic insulating film 2 and the thin films making up the laminated body were formed in the conditions shown below.

Inorganic Insulating Film 2

The inorganic insulating film 2 was formed by the following sputtering system in the following conditions:

Sputtering system (manufactured by Canon Anelva corporation, product name: C-3103)

Target composition: SCZ (SiO₂ 35 atomic %+Cr₂O₃ 30 atomic %+ZrO₂ 35 atomic %)

Target size: Φ6 inches

Sputtering gas: Ar 100 sccm, 0.13 Pa

Sputtering power: 1000 W (RF)

(Positive Current Collector Film 3)

The positive current collector film 3 was formed by the following sputtering system in the following conditions:

Sputtering system (manufactured by ULVAC Inc., product name: SMO-01 (customized))

Target composition: Ti

Target size: Φ4 inches

Sputtering gas: Ar 70 sccm, 0.45 Pa

Sputtering power: 1000 W (DC)

Film thickness: 100 nm

(Positive Active Material Film 4)

The positive active material film 4 was formed by the following sputtering system in the following conditions:

Sputtering system (manufactured by ULVAC Inc., product name: SMO-01 (customized))

Target composition: Co-sputtering with Li₃PO₄ and Cu or Li₃PO₄ and Cu co-sputtering

Target size: Φ4 inches

Sputtering gas: Ar 20 sccm+N₂ 100 sccm, 0.65 Pa

Sputtering power: Li₃PO₄ 600 W (RF)+Cu 50 W (DC)

Film thickness: 280 nm

Solid-State Electrolyte Film 5

The solid-state electrolyte film 5 was formed by the following sputtering system in the following conditions:

Sputtering system (manufactured by ULVAC Inc., product name: SMO-01 (customized))

Target composition: Li₃PO₄

Target size: Φ4 inches

Sputtering gas: Ar 20 sccm+N2 20 sccm, 0.26 Pa

Sputtering power: 600 W (RF)

Film thickness: 480 nm

Negative Potential Formation Layer 6

The negative potential formation layer 6 was formed by the following sputtering system in the following conditions:

Sputtering system (manufactured by ULVAC Inc., product name: SMO-01 (customized))

Target composition: LiCoO₂

Target size: Φ4 inches

Sputtering gas: (mixed gas of Ar 80% and O2 20%) 20 sccm, 0.20 Pa

Sputtering power: 300 W (RF)

Film thickness: 10 nm

Negative Current Collector Film 7

The negative current collector film 7 was formed by the following sputtering system in the following conditions:

Sputtering system (manufactured by ULVAC Inc., product name: SMO-01 (customized))

Target composition: Ti

Target size: Φ4 inches

Sputtering gas: Ar 70 sccm, 0.45 Pa

Sputtering power: 1000 W (DC)

Film thickness: 200 nm

Finally, the overall protective film 8 was formed by using an ultraviolet hardening resin (manufactured by Sony Chemical & Information Device Corporation, model number: SK3200). The solid-state lithium-ion battery used in the present invention is configured as described above. That is, the solid-state lithium-ion battery including the following films was obtained.

Film Configuration of Solid-State Lithium-Ion Battery

Polycarbonate substrate/SCZ (50 nm)/Ti (100 nm)/LiCuPO₄ (280 nm)/Li₃PO₄Nₓ (480 nm)/LiCoO₂ (10 nm)/Ti (200 nm)/ultraviolet hardening resin (20 μm)

Charge/Discharge Characteristic of Solid-State Lithium-Ion Battery

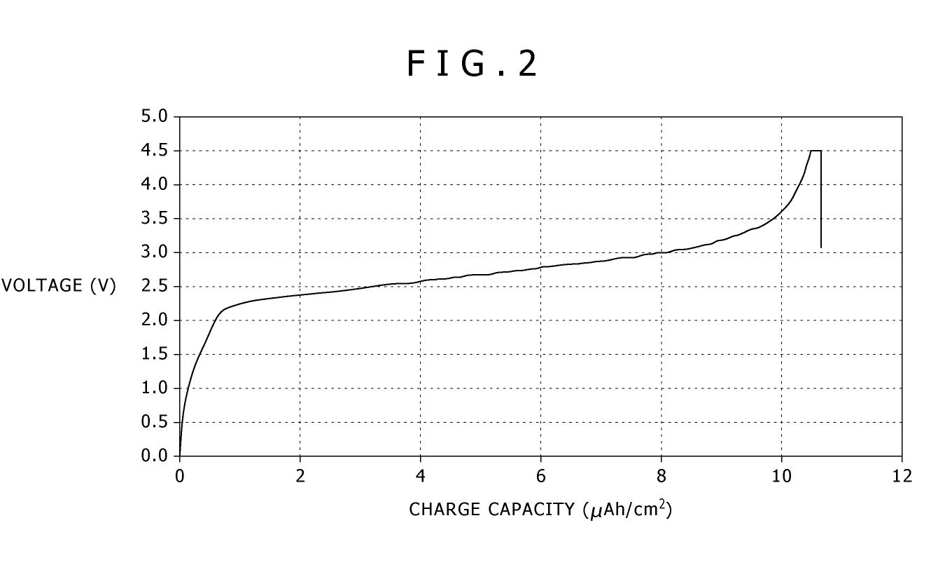

FIG. 2 illustrates the charge characteristic of the above solid-state lithium-ion battery when the battery is charged as a secondary battery, with the vertical axis representing the battery voltage and the horizontal axis the charge capacity. The battery was charged through common constant current/constant voltage charge. A constant current charge was conducted at 0.3 mA until the charge capacity reached approximately 7 μAh/cm². The battery was switched to a constant voltage charge when the battery voltage reached 4.1 V. The charge was terminated when the current level dropped to one tenth the level during a constant current charge or 0.03 mA. It should be noted that the charge capacity of the solid-state lithium-ion battery used in the present embodiments is approximately 11 μAh/cm² when the state of charge (SOC) is 100%. However, the charge capacity is not limited thereto, and a secondary battery with an even larger charge capacity may be used.

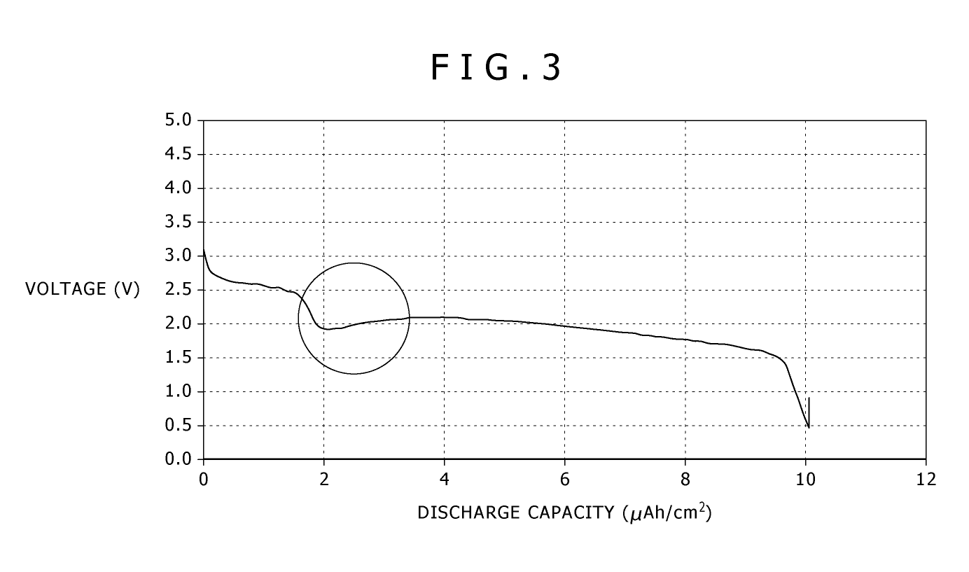

The graph of FIG. 3 illustrates the charge characteristic of the solid-state lithium-ion battery charged through the above constant current/constant voltage charge. The battery was discharged entirely through constant current discharge, with the current level set to 0.3 mA. As illustrated in FIG. 3, after the discharge begins, the battery voltage basically drops gradually as the discharge progresses. However, the battery voltage drop does not trace a smooth curve. Instead, the voltage drops steeply in the area enclosed by a circle in the graph of FIG. 3 (when the charge capacity is from about 2 to 3 μAh/cm²). This is presumably caused by a steep rise in impedance of the positive active material in this range.

It is probable, based on the relationship between the charge capacity and discharge capacity, that the range in which the voltage drops steeply in the discharge process corresponds to that in which the charge capacity is about 8 μAh/cm² or higher in the charge characteristic shown in FIG. 2. In the charge characteristic shown in FIG. 2, however, both the voltage and current levels do not change significantly when the charge capacity is about 8 μAh/cm². Therefore, even if the voltage or current level is detected during a constant current/constant voltage charge, it cannot be determined based on the relationship between the charge capacity and voltage or current level whether the charge is complete. Although the current level can be integrated in principle, an integrating circuit, memory and other components must be attached to the charger in order to respond to possible charge during a discharge, thus resulting in higher cost. Still further, it is impossible to deal with hysteresis or battery degradation.

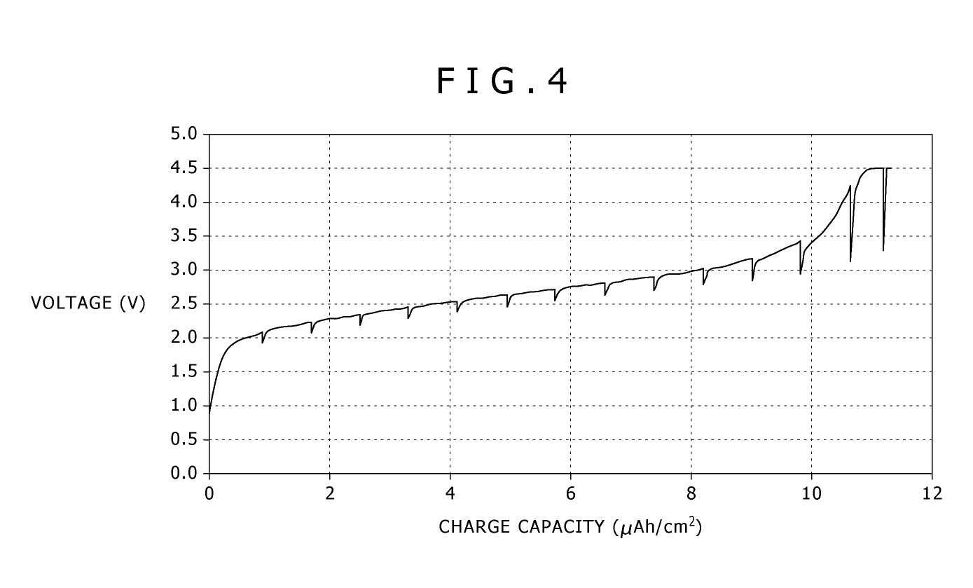

For this reason, the solid-state lithium-ion battery is charged through a pulsed charge. FIG. 4 illustrates the charge characteristic of the solid-state lithium-ion battery when the battery is charged through pulsed charge. The battery was charged through pulsed charge and common constant current/constant voltage charge. A constant current charge was conducted at 0.3 mA until the charge capacity reached approximately 7 μAh/cm². The battery was switched to a constant voltage charge when the battery voltage reached 4.1 V. The charge was terminated when the current level dropped to one tenth the level during a constant current charge or 0.03 mA. Further, a pulsed charge was conducted by charging the battery for 0.5 minutes and then pausing the charge for one minute. During a pause, the terminals of the solid-state lithium-ion battery were left open so that only the open circuit voltage (OCV) was detected. Here, the open circuit voltage refers to the voltage across the terminals of the solid-state lithium-ion battery detected with its two electrodes left open-circuited.

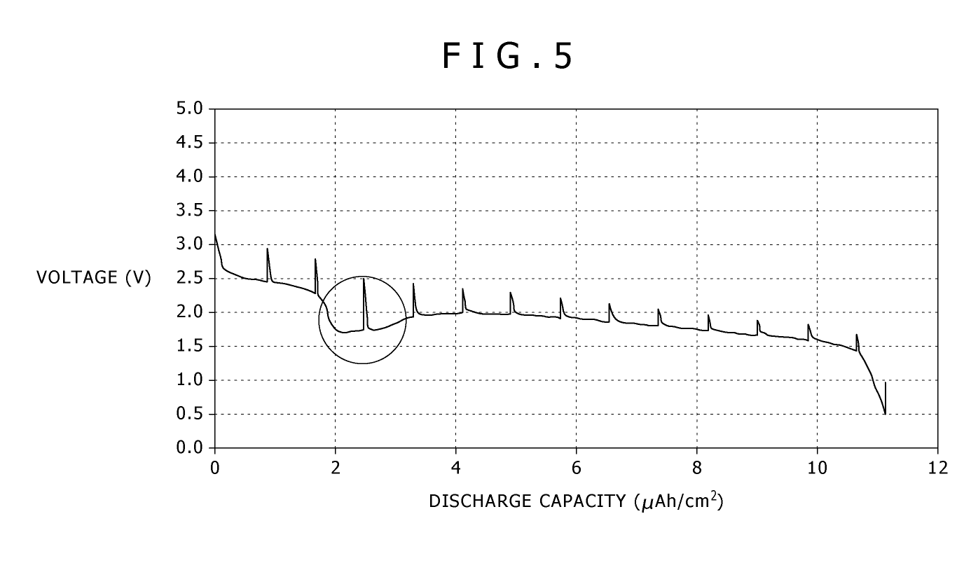

The graph in FIG. 5 illustrates the discharge characteristic of the solid-state lithium-ion battery that has been charged through pulsed charge as illustrated in FIG. 4. The battery was discharged entirely through constant current discharge, with the current level set to 0.3 mA.

As illustrated in FIG. 5, the voltage drops steeply in the area enclosed by a circle (when the charge capacity is from about 2 to 3 μAh/cm²) when the battery was charged through pulsed charge as with the graph shown in FIG. 3 when the battery was charged without pulsed charge. Therefore, if the current level is increased, for example, to 1 mA, the battery functions properly with its voltage remaining almost unchanged for a discharge depth of 3 μAh/cm² or more. However, the battery does not function properly for a discharge depth of 3 μAh/cm² or less because the voltage drops excessively. Therefore, the charge is terminated when the battery is charged to 8 μAh/cm² which is the difference between 11 μAh/cm² when the state of charge (SOC) of the battery is 100% and 3 μAh/cm². This permits charge and discharge in a range free from a steep voltage drop, thus allowing for the battery to function properly.

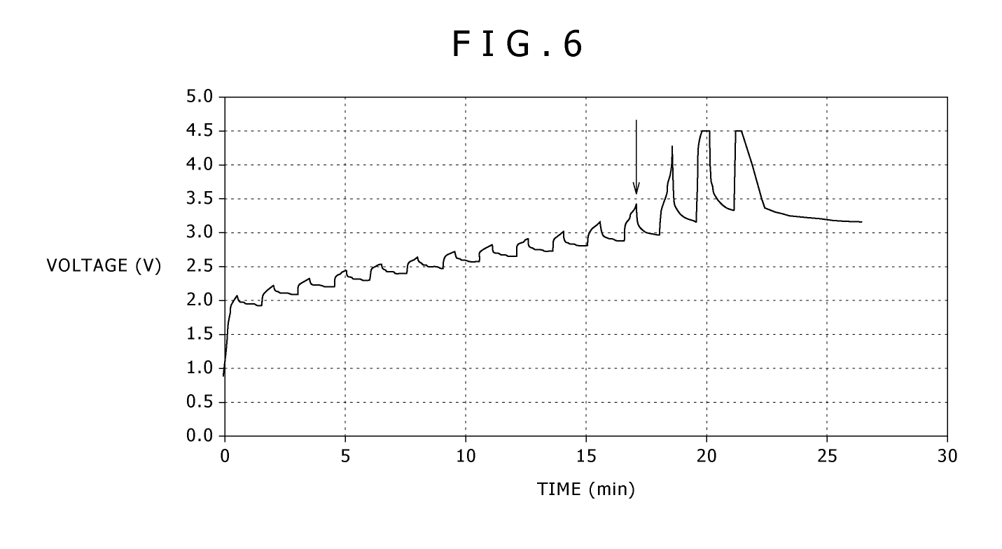

The graph shown in FIG. 6 is obtained by translating the charge characteristic of the solid-state lithium-ion battery shown in FIG. 4 into a relationship between the battery voltage and charge time with the horizontal axis representing the charge time. A pulsed charge causes the overall voltage to rise gradually by repeating a cycle of voltage rise resulting from a charge and voltage drop resulting from a pause. At the point indicated by an arrow in FIG. 6 and beyond, however, the voltage drops to a greater extent during a pause condition than earlier (pause condition for a period of 15 minutes from a zero-minute charge time. This range in which the voltage drops significantly corresponds to that in which the charge capacity is about 8 μAh/cm² or higher in the graph shown in FIG. 4. Therefore, if the open circuit voltage is detected in a pause condition during a pulsed charge, it is possible to terminate the charge by determining that the charge capacity has reached 8 μAh/cm².

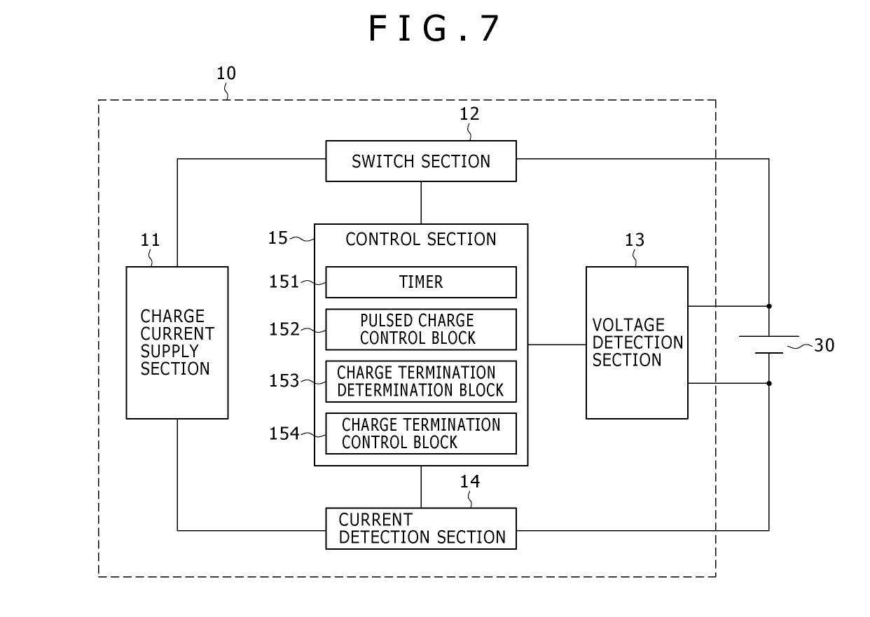

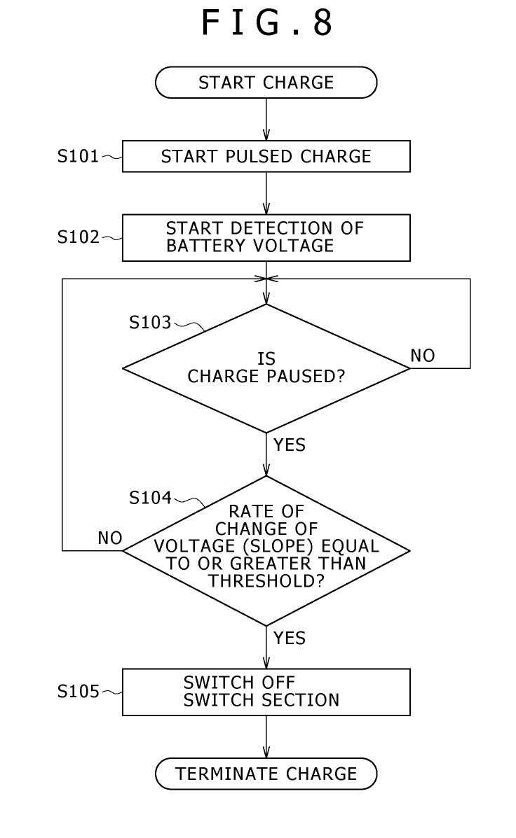

For this reason, the process steps shown in FIG. 8 are performed by a charger 10 according to the first embodiment shown in FIG. 7. This permits charge and discharge only in a high ionic conductivity range, thus preventing steep voltage drop at an early stage of charge.

Configuration of Charger

As illustrated in FIG. 7, the charger 10 includes a charge current supply section 11, switch section 12, voltage detection section 13, current detection section 14 and control section 15. On the other hand, the control section 15 includes a timer 151, pulsed charge control block 152, charge termination determination block 153 and charge termination control block 154.

A solid-state lithium-ion secondary battery 30 (hereinafter referred to as the secondary battery 30) to be charged is connected to the charger 10.

The charge current supply section 11 is a power circuit adapted to supply a charge current to the secondary battery 30 for charging purpose. The switch section 12 includes a charge switch and a discharge switch. The charge switch turns on or off the current flowing in the direction to charge the secondary battery 30. The discharge switch turns on or off the current flowing in the direction to discharge the secondary battery 30. The switch section 12 is connected to the charge current supply section 11 and the positive electrode of the secondary battery 30. The switch section 12 is also connected to the control section 15. The on/off conditions of the switch section 12 are changed according to a control signal from the control section 15. This allows for a charge current to be supplied periodically from the charge current supply section 11 to the secondary battery 30 for pulsed charge. Further, the switch section 12 is turned off by a control signal from the control section 15, shutting off charge current supply to the secondary battery 30 and thereby terminating the charge. A semiconductor switching element such as FET (Field Effect Transistor) may be used as the switch section 12.

The voltage detection section 13 detects the voltage of the secondary battery 30, converts the detected analog signal into a digital signal with an A/D converter (not shown) and supplies the digital signal to the control section 15.

The current detection section 14 is connected to the negative electrode of the secondary battery 30 and the charge current supply section 11. The same section 14 outputs, for example, a voltage resulting from a current flow through a resistive element, thus detecting a charge current supplied from the charge current supply section 11 to the secondary battery 30.

The control section 15 is a microcomputer which includes, for example, a CPU (Central Processing Unit). The same section 15 is connected to the switch section 12, voltage detection section 13 and current detection section 14 and controls each section of the charger 10 to charge the battery.

The timer 151 sets the intervals at which to repeat a cycle of charge condition and pause condition for pulsed charge. In the present embodiment, a pulsed charge is conducted so that a cycle of a half-minute charge followed by a one-minute pause is repeated. It should be noted, however, that the charge time and pause time are not limited to the above. It is only necessary to be able to detect the open circuit voltage during a pause condition as described later. Therefore, a pause condition may last one minute or less so long as the open circuit voltage can be detected.

The pulsed charge control block 152 transmits a control signal to the switch section 12 at the intervals set by the timer 151, thus turning on or off the switch section 12 and periodically supplying a charge current from the charge current supply section 11 to the secondary battery 30 for pulsed charge.

The charge termination determination block 153 detects the change in ionic conductivity based on the open circuit voltage detected by the voltage detection section 13, thus determining whether to terminate the charge. The determination process handled by the same block 153 will be described in detail later. The charge termination control block 154 turns off the switch section 12 based on the determination result of the charge termination determination block 153, shutting off charge current supply to the secondary battery 30 and thereby terminating the charge. The charger 10 is configured as described above to include a current path adapted to charge the secondary battery 30.

Operation of Charger

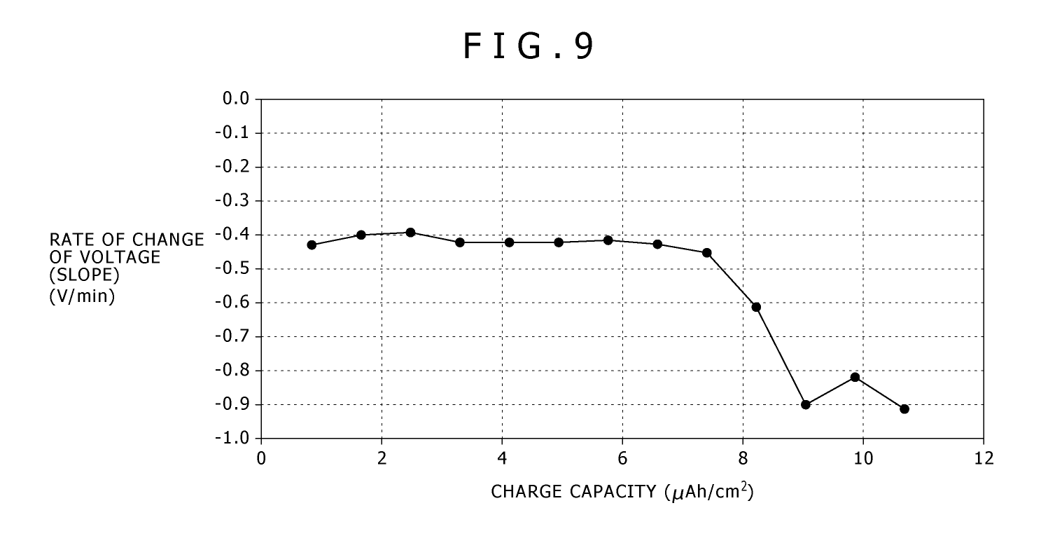

A description will be given below of the operation of the charger 10 configured as described above with reference to the flowchart shown in FIG. 8 and the graphs shown in FIGS. 9 to 11. First of all, when a charge begins, the pulsed charge control block 152 changes the on/off conditions of the switch section 12 according to the intervals set by the timer 151 in step S101, periodically supplying a charge current from the charge current supply section 11 to the secondary battery 30. This initiates a pulsed charge, periodically repeating a cycle of a charge condition adapted to charge the secondary battery 30 and a pause condition adapted to pause a charge current supply to the secondary battery 30. In the present embodiment, a pulsed charge is conducted so that a cycle of a half-minute charge followed by a one-minute pause is repeated. It should be noted, however, that the charge time and pause time are not limited to the above. It is only necessary to be able to detect the open circuit voltage during a pause condition as described later. Therefore, a pause condition may last one minute or less so long as the open circuit voltage can be detected. On the other hand, a charge is conducted through constant current charge at 0.3 mA.

Next in step S102, the voltage detection section 13 begins to detect the voltage of the secondary battery 30. The battery voltage is detected, for example, at one-second intervals at all times together with the charge until the charge ends. It should be noted, however, that the detection intervals are not limited to one second. Instead, if the change in battery voltage must be detected in a more detailed manner, the battery voltage may be detected at shorter time intervals. It should be noted that a charge of the secondary battery 30 is paused during a pulsed charge. The open circuit voltage is detected with the two electrodes of the secondary battery 30 left open-circuited.

Next in step S103, it is determined whether the pulsed charge is paused. Whether the charge is paused can be determined by the control section 15, for example, based on the current level detected by the current detection section 14. If it is determined that the charge is not paused (No in step S103), the detection of the battery voltage and the charge of the secondary battery 30 through pulsed charge continue while at the same time repeating the determination in step S103.

When it is determined in step S103 that the charge is paused, the process proceeds to step S104 (Yes in step S103). In step S104, the charge termination determination block 153 detects the change in ionic conductivity based on the detected open circuit voltage, thus determining whether to terminate the pulsed charge.

A description will be given here of the determination made in step S104. FIG. 9 illustrates the relationship between the charge capacity of the secondary battery 30 and the rate of change (slope) of the open circuit voltage. FIG. 9 shows the rate of change (slope) of the open circuit voltage along the vertical axis, and the charge capacity along the horizontal axis for five seconds immediately after a pause condition begins during a pulsed charge. As can be verified from FIG. 6, the voltage changes significantly at an early stage of a pause condition of the pulsed charge, and then changes gradually to a lesser extent later. Therefore, higher accuracy can be achieved by measuring immediately after a pause condition begins. It should be noted, however, that the period of five seconds is merely an example and dependent upon the material used as a positive active material. The period over which the rate of change (slope) is to be calculated is not necessarily limited to five seconds. This period may be preferably shorter or longer for other positive active materials. Therefore, the period should be set as appropriate in accordance with the positive active material used.

As illustrated in FIG. 9, the absolute value of the rate of change (slope) of the open circuit voltage for a period of five seconds immediately after the beginning of a pause condition is more or less constant when the charge capacity is from about 1 μAh/cm² to about 8 μAh/cm². However, the absolute value thereof increases as the charge capacity approaches 8 μAh/cm², and increases steeply when the charge capacity exceeds about 8 μAh/cm². Therefore, the charge is terminated when the charge capacity reaches 8 μAh/cm² where the rate of change (slope) of the open circuit voltage increases steeply. This permits charge and discharge in a range free from a steep change in battery voltage.

As described above, the absolute value of the rate of change (slope) of the open circuit voltage for a period of five seconds immediately after the beginning of a pause condition increases steeply when the charge capacity exceeds about 8 μAh/cm². More specifically, the rate of change (slope) of the open circuit voltage is about 0.6 V when the charge capacity reaches about 8 μAh/cm². That is, it can be said that the rate of change (slope) of the open circuit voltage increases to a larger extent from −0.6 V. The range in which the rate of change (slope) of the open circuit voltage exceeds −0.6 V corresponds to that in which the drop in open circuit voltage during a pause condition becomes greater than the drop during the earlier pause conditions (range from the point indicated by an arrow in FIG. 6 and beyond).

In step S104, therefore, it is only necessary to specify −0.6 V as a first threshold and determine whether the rate of change (slope) of the open circuit voltage exceeds the first threshold of −0.6 V for a period of five seconds after a pause condition begins. This allows for accurate detection of the change in ionic conductivity, thus making it possible to determine whether to terminate the charge.

As described above, the first threshold is empirically found in advance and set. Therefore, the first threshold is not limited to the above. Instead, this value presumably varies depending upon the material used as a positive active material of the solid-state lithium-ion battery and its composition. Therefore, the first threshold should be optimally set as appropriate in consideration of the material used and other factors.

If it is determined in step S104 that the rate of change (slope) of the open circuit voltage does not exceed the first threshold, the process returns to step S103 (No in step S104). The detection of the battery voltage and the charge of the secondary battery 30 through pulsed charge continue while at the same time repeating the determination in step S103.

When it is determined in step S103 that the charge is paused, the process proceeds to step S104 (Yes in step S103) where it is determined whether the rate of change (slope) of the open circuit voltage exceeds the first threshold of −0.6 V for a period of five seconds after a pause condition began. Unless it is determined in step S104 that the first threshold is exceeded, the detection of the battery voltage and the charge of the secondary battery 30 through pulsed charge continue while at the same time repeating steps S103 and S104.

Then if it is determined in step S104 that the rate of change (slope) of the open circuit voltage exceeds the first threshold, the process proceeds to step S105 (Yes in step S104). Next in step S105, the charge termination control block 154 transmits a control signal to the switch section 12 to terminate the charge according to the determination result of the charge termination determination block 153. The switch section 12 is turned off according to the control signal, thus shutting off charge current supply to the secondary battery 30 and thereby terminating the charge. That is, the case in which it is determined that the rate of change (slope) of the open circuit voltage exceeds the first threshold of −0.6 V indicates that the charge capacity has reached 8 μAh/cm². As a result, terminating the charge at this point in time permits charge and discharge in a range free from a steep change in the battery voltage.

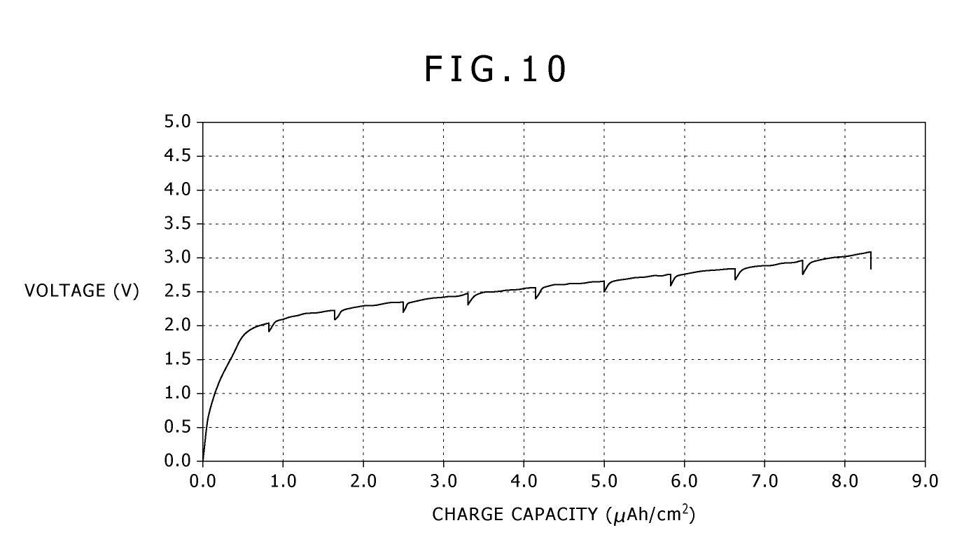

FIG. 10 is a graph illustrating the charge characteristic of the secondary battery 30 charged by the charger 10 according to the present invention. In the present embodiment, the charger 10 is set to terminate the charge when the rate of change (slope) of the open circuit voltage exceeds the first threshold of −0.6 V. As a result, the charge is terminated when the rate of change (slope) exceeds 0.6 V, i.e., when the charge capacity exceeds 8 μAh/cm².

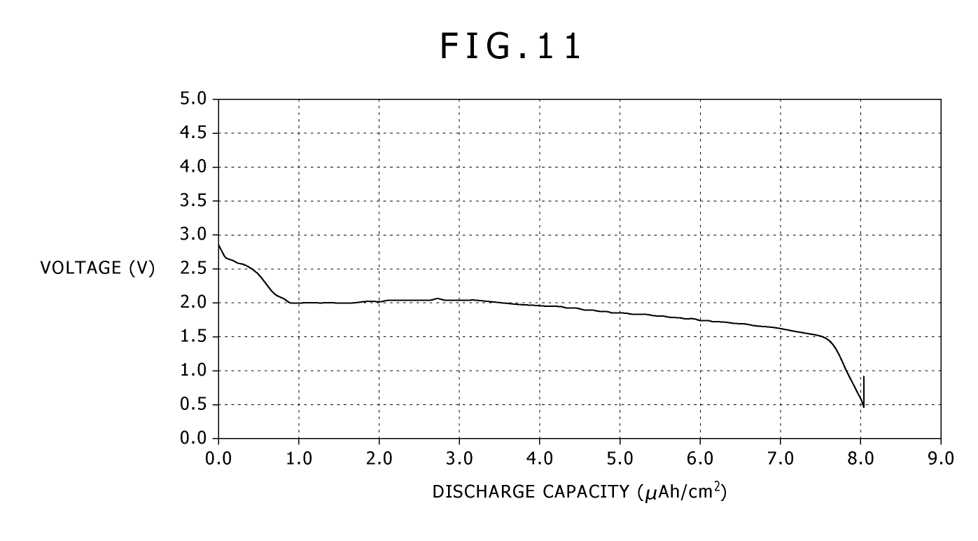

The graph shown in FIG. 11 illustrates the discharge characteristic of the secondary battery 30 charged by the charger 10 according to the present invention. The secondary battery 30 does not develop any steep voltage drop at an early stage of the discharge observed in FIGS. 3 and 5, thus showing a curve with a smooth voltage drop. Thus, the charge and discharge only in a high ionic conductivity range free from a steep voltage drop allows for the secondary battery to function properly, thus permitting fast discharge.

### 2. Second Embodiment

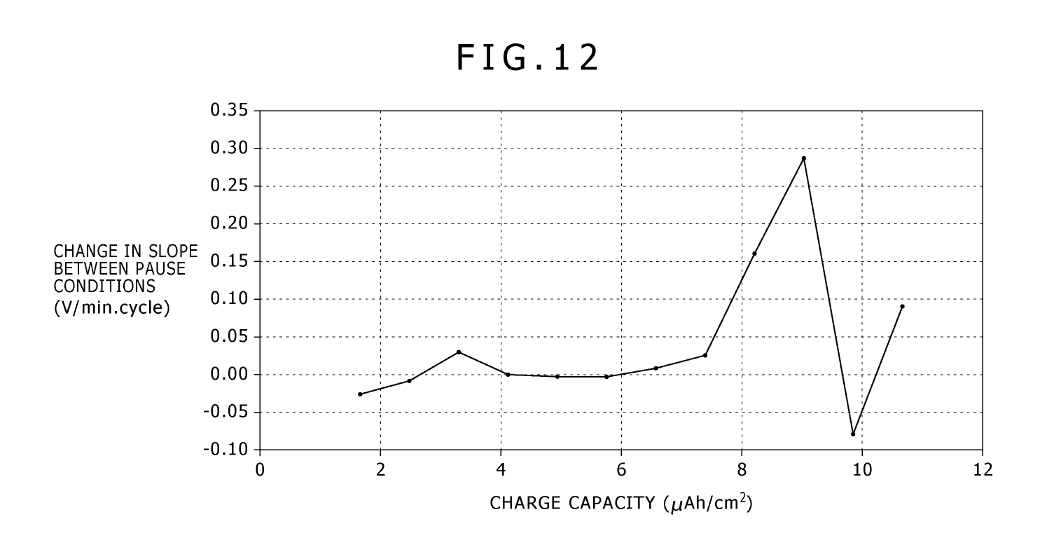

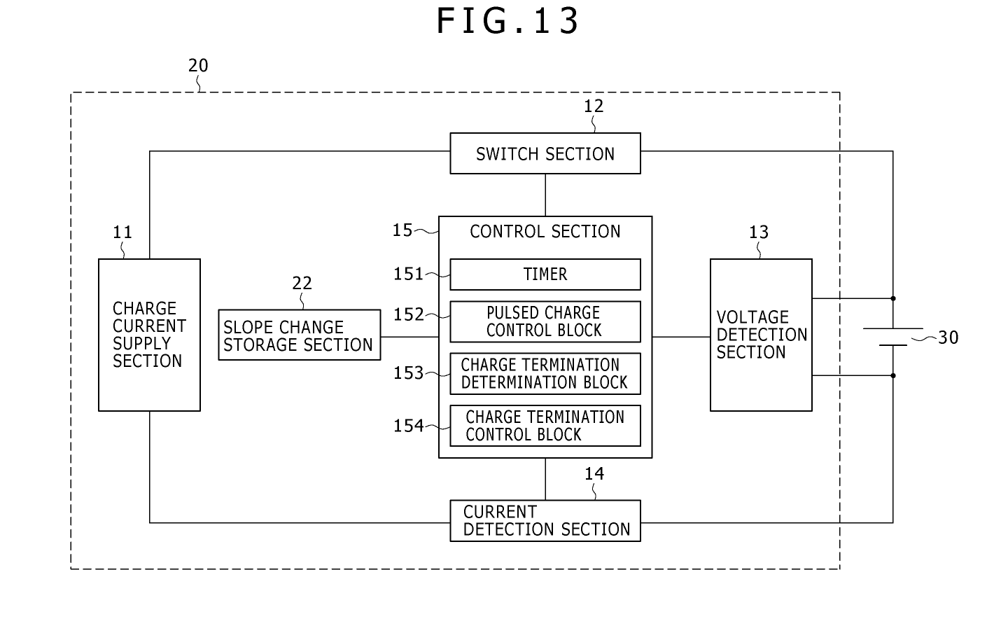

A description will be given below of a second embodiment with reference to FIGS. 12 to 14. It should be noted that the same reference numerals are assigned to the same components as those of the first embodiment, and the description thereof will be omitted.

The value shown in the graph of FIG. 12 represents the change in the rate of change (slope) of the open circuit voltage between pause conditions of pulsed charge for a period of five seconds immediately after the beginning of a pause condition shown in FIG. 9. That is, the graph shows the difference between the rate of change (slope) of the open circuit voltage for a period of five seconds immediately after the beginning of a pause condition and that immediately after the beginning of a previous pause condition. It should be noted that the value shown in FIG. 12 will be hereinafter referred to as the change in slope between pause conditions. In FIG. 9, the rate of change (slope) of the battery voltage remains constant at around −4 V until the charge capacity reaches about 8 μAh/cm². Therefore, the change in slope between pause conditions shown in FIG. 12 is close to zero. However, the change in slope between pause conditions increases steeply immediately before the charge capacity reaches about 8 μAh/cm². The change in slope between pause conditions is 0.15 V/min when the charge capacity reaches about 8 μAh/cm². As a result, the charge is terminated if the change in slope between pause conditions varies by 0.15 V/min or more from the previous change. This permits charge and discharge only in a high ionic conductivity range free from a steep drop in battery voltage.

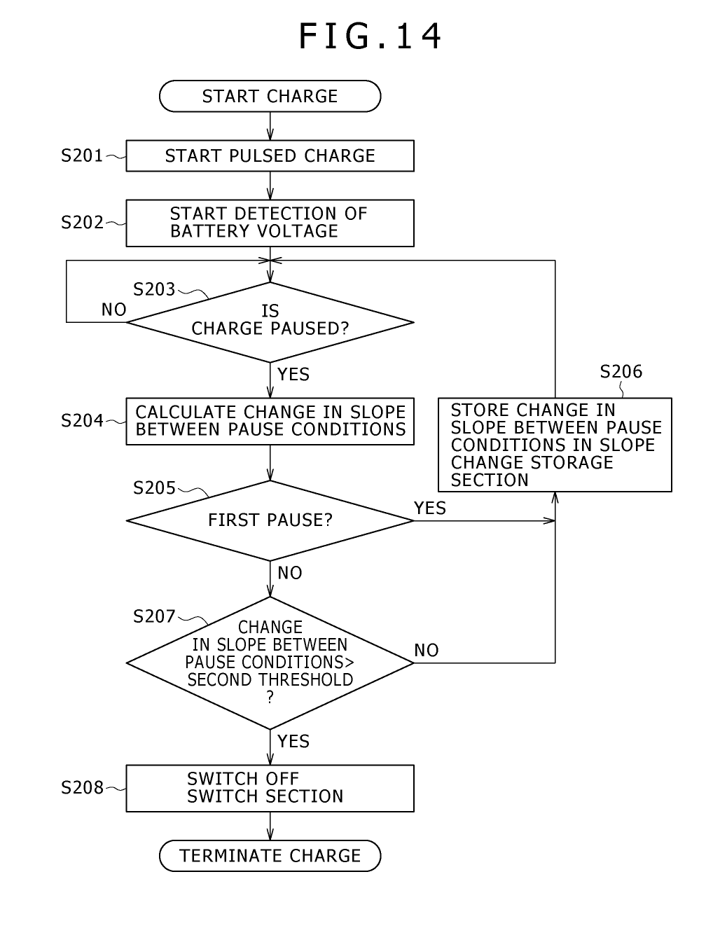

For this reason, the process steps shown in FIG. 14 are performed by a charger 20 according to the second embodiment.

Configuration of Charger

The charger 20 includes the charge current supply section 11, switch section 12, voltage detection section 13, current detection section 14, control section 15 and slope change storage section 22. On the other hand, the control section 15 includes the timer 151, pulsed charge control block 152, charge termination determination block 153 and charge termination control block 154. The charge current supply section 11, switch section 12, voltage detection section 13 and current detection section 14 making up the charger 20 are configured in the same manner as in the first embodiment. Similarly, the timer 151, pulsed charge control block 152, charge termination determination block 153 and charge termination control block 154 making up the control section 15 are configured in the same manner as in the first embodiment. The second embodiment differs from the first embodiment in that the charger 20 includes the slope change storage section 22.

In the second embodiment, the charge termination determination block 153 calculates the change in slope between pause conditions based on the open circuit voltage detected by the voltage detection section 13. The slope change storage section 22 includes a storage medium such as memory connected to the control section 15 and stores the change in slope between pause conditions calculated by the charge termination determination block 153. Although described in detail later, the stored change in slope between pause conditions is used by the charge termination determination block 153 to determine whether to terminate the charge.

The secondary battery 30 to be charged is connected to the charger 20. The same battery as used in the first embodiment is used as the secondary battery 30.

Operation of Charger

A description will be given below of the operation of the charger 20 configured as described above. First of all, the pulsed charge control block 152 changes the on/off conditions of the switch section 12 according to the intervals set by the timer 151 in step S201, periodically supplying a charge current from the charge current supply section 11 to the secondary battery 30. This initiates a pulsed charge, periodically repeating a cycle of a charge condition and a pause condition. The second embodiment is similar to the first embodiment in that a pulsed charge is conducted so that a cycle of a half-minute charge followed by a one-minute pause is repeated. It should be noted that the second embodiment is also similar to the first embodiment in that the charge time and pause time are not limited to the above. A constant current charge is conducted at 0.3 mA.

Next in step S202, the voltage detection section 13 begins to detect the voltage of the secondary battery 30. The battery voltage is detected, for example, at one-second intervals at all times together with the charge. It should be noted that the detection intervals are also not limited to one second in the second embodiment.

Next in step S203, it is determined whether the charge of the secondary battery 30 is paused. If it is determined that the charge is not paused (No in step S203), the charge of the secondary battery 30 through pulsed charge and the detection of the battery voltage continue while at the same time repeating the determination in step S203.

When it is determined in step S203 that the charge is paused, the process proceeds to step S204 (Yes in step S203). In step S204, the charge termination determination block 153 calculates the change in slope between pause conditions. The change in slope between pause conditions is calculated as a difference between the rate of change (slope) of the open circuit voltage for a period of five seconds after the beginning of a pause condition during which it has been determined that the charge is paused and that immediately after the beginning of the previous pause condition.

It should be noted that there is no previous pause condition for the first pause condition. Therefore, the value 0 should be used as an alternative to the rate of change (slope) of the open circuit voltage for a period of five seconds immediately after the beginning of the previous pause condition.

Next in step S205, it is determined whether the pause condition determined to have been reached in step S203 is the first pause condition. If the pause condition is the first one, no change in slope between pause conditions has been stored in the slope change storage section 22. As a result, it is impossible to make a determination in step S207 which will be described later. Step S205 is provided when the pause condition is the first one so as to store the change in slope between pause conditions calculated in step S204 in the slope change storage section 22 rather than proceeding to step S207 to make a determination. If it is determined that the pause condition is the first one, the process proceeds to step S206 (Yes in step S205).

If the process proceeds to step S206 after it has been determined that the pause condition is the first one, the change in slope between pause conditions calculated in step S204 is stored in the slope change storage section 22. This change in slope between pause conditions stored in the slope change storage section 22 is used to make a determination in step S207 which will be described later.

Then, the process returns to step S203 where the charge of the secondary battery 30 through pulsed charge and the detection of the battery voltage continue while at the same time repeating again the determination as to whether a next pause condition has been reached.

When it is determined that a pause condition is reached in step S203, the process proceeds to step S204 (Yes in step S203). In step S204, the charge termination determination block 153 calculates the change in slope between the pause condition determined to have been reached in step S203 and the previous pause condition.

Next in step S205, it is determined whether the pause condition reached in step S203 is the first pause condition. When the pause condition is the second one or later, the process proceeds to step S207 (No in step S205). It should be noted that when the pause condition is the second one or later, the process will not proceed from step S205 to step S206.

Next in step S207, the charge termination determination block 153 determines whether the change in slope between pause conditions calculated in step S204 exceeds the second threshold.

A description will be given here of the determination made in step S207 and the second threshold. As illustrated in FIG. 12, the change in slope between pause conditions shown is close to zero until the charge capacity reaches 8 μAh/cm² because the rate of change (slope) of the open circuit voltage is constant. However, the change in slope between pause conditions increases steeply immediately before the charge capacity reaches about 8 μAh/cm². The change in slope between pause conditions is 0.15 V/min when the charge capacity reaches about 8 μAh/cm². Therefore, the sum of the previous change in slope between pause conditions and a constant value is set as the second threshold. Further, 0.15 V/min is set as a constant value. Then, it is necessary to terminate the charge when the change in slope between pause conditions in the pause condition determined to be reached exceeds the second threshold. This permits charge and discharge in a range free from a steep change in the battery voltage based on the ionic conductivity.

As described above, the second threshold and constant value are, for example, empirically set in advance. Therefore, the constant value is not limited to 0.15 V/min. Instead, this value presumably varies significantly depending upon the material used as a positive active material of the solid-state lithium-ion battery and its composition. Therefore, the constant value should be optimally set as appropriate in consideration of the material used and other factors.

If the charge termination determination block 153 determines in step S207 that the change in slope between pause conditions does not exceed the second threshold, the process proceeds to step S206 (No in step S207). Then, the change in slope between pause conditions calculated in step S204 is stored in the slope change storage section 22 in step S206. This updates the change in slope between pause conditions stored in the slope change storage section 22. It should be noted that all the calculated changes in slope between pause conditions may be stored in the slope change storage section 22 rather than updating the change in slope between pause conditions as occasion arises by storing the change in the slope change storage section 22.

Then, the process returns to step S203. So long as it is determined in step S207 that the change in slope between pause conditions does not exceed the second threshold, steps S203 to S207 will be repeated. That is, it is determined whether the charge is paused, the change in slope between pause conditions calculated, the change in slope between pause conditions compared against the second threshold to determine whether to terminate the charge, and the change in slope between pause conditions stored in the slope change storage section 22. The change in slope between pause conditions shown in FIG. 12 is obtained by repeating steps S203 to S207.

Then, when the charge termination determination block 153 determines in step S207 that the change in slope between pause conditions exceeds the second threshold, the process proceeds to step S208 (Yes in step S207). Next in step S208, the charge termination control block 154 transmits a control signal to the switch section 12 to terminate the charge according to the determination result of the charge termination determination block 153. The switch section 12 is turned off according to the control signal, thus shutting off charge current supply to the secondary battery 30 and thereby terminating the charge.

When the secondary battery 30 is charged by the charger 20 according to the second embodiment, the charge is also terminated if the charge capacity exceeds 8 μAh/cm2. When the secondary battery 30 charged by the charger 20 according to the second embodiment is discharged, the secondary battery 30 does not develop any steep voltage drop at an early stage of the discharge as illustrated in the graph of FIG. 11, thus showing a curve with a smooth voltage drop. Thus, the charge and discharge only in a high ionic conductivity range free from a steep voltage drop allows for the secondary battery to function properly, thus permitting fast discharge.

Thanks to the above process steps, the second embodiment does not determine that the charge is complete even if the rate of change (slope) of the open circuit voltage varies slowly, thus allowing for detection of a steep change in battery voltage. This makes it possible to detect a high impedance region with high accuracy, thus terminating the charge.

While preferred embodiments have been specifically described above, the present invention is not limited to the above embodiments and may be modified in various manners based on the technical concept thereof. For example, constant current/constant voltage charge is not performed in the present embodiments. However, constant current/constant voltage charge may be performed together with pulsed charge. Further, although the description was made by giving specific values for the charge capacity, thresholds and other data, these pieces of data are not limited to the cited values. Instead, these pieces of data should be optimally set as appropriate in consideration of the material used as a positive active material of the solid-state lithium-ion battery and its composition.

Further, the present invention is not limited in application to the solid-state lithium-ion battery used in the above embodiments. Instead, the present invention is also applicable to other types of secondary batteries using a positive active material whose ionic conductivity changes steeply in the discharge process, as a result of which the voltage drops significantly.

Still further, although the rate of change (slope) of the open circuit voltage for a period of five seconds after a pause condition begins is used to determine whether to terminate the charge in the present embodiments, whether to terminate the charge may be determined, for example, by detecting the battery voltage, calculating the rate of change (slope) and comparing the rate of change against the threshold at one-second intervals.

Still further, if the secondary battery having the above charge and discharge characteristics is used to configure a battery pack, a device adapted to handle the process steps according to the present invention may be incorporated in the battery pack. Alternatively, such a device may be incorporated in the equipment to which the battery pack is attached.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

1. A secondary battery charge method, comprising the steps of:
conducting a pulsed charge control adapted to conduct a pulsed charge by repeating a cycle of a charge condition and a pause condition of a secondary battery at predetermined intervals;
detecting a voltage detection adapted to detect the voltage of the secondary battery;
determining a charge termination determination adapted to determine whether to terminate the charge of the secondary battery based on the battery voltage in a pause condition detected by the voltage detection step; and
terminating a charge termination control adapted to terminate the pulsed charge when it has been determined by the charge termination determination step that the charge should be terminated.

2. The secondary battery charge method of claim 1, wherein
the charge termination determination step compares the rate of change of the battery voltage in the pause condition against a first threshold and determines that the charge of the secondary battery should be terminated if the rate of change of the battery voltage in the pause condition exceeds the first threshold.

3. The secondary battery charge method of claim 2, wherein
the rate of change of the battery voltage in the pause condition is the rate of change of the battery voltage over time for a predetermined period of time after the beginning of the pause condition.

4. The secondary battery charge method of claim 1, wherein
the charge termination determination step calculates the difference between the rate of change of the battery voltage in the pause condition and the rate of change of the battery voltage in the previous pause condition and determines whether to terminate the charge of the secondary battery based on the difference between the rates of change of the battery voltage.

5. The secondary battery charge method of claim 4, wherein
the charge termination determination step compares the difference between the rates of change of the battery voltage against a second threshold and determines that the charge of the secondary battery should be terminated if the difference between the rates of change of the battery voltage exceeds the second threshold.

6. The secondary battery charge method of claim 1, wherein
the secondary battery is a lithium-ion battery using LiCuPON as a positive active material.

7. A secondary battery charger, comprising:
a pulsed charge control unit adapted to conduct a pulsed charge by repeating a cycle of a charge condition and a pause condition of a secondary battery at predetermined intervals;
a voltage detection unit adapted to measure the voltage of the secondary battery;
a charge termination determination unit adapted to determine whether to terminate the charge of the secondary battery based on the battery voltage in a pause condition detected by the voltage detection step; and
a charge termination control unit adapted to terminate the pulsed charge when it has been determined by the charge termination determination step that the charge should be terminated.

8. A secondary battery charger, comprising:
pulsed charge control means for conducting a pulsed charge by repeating a cycle of a charge condition and a pause condition of a secondary battery at predetermined intervals;
voltage detection means for measuring the voltage of the secondary battery;
charge termination determination means for determining whether to terminate the charge of the secondary battery based on the battery voltage in a pause condition detected by the voltage detection step; and
charge termination control means for terminating the pulsed charge when it has been determined by the charge termination determination step that the charge should be terminated.
